(19) United States
(12) Patent Application Publication
(10) Pub. No.: US 2025/0260846 A1
(43) Pub. Date: Aug. 14, 2025

(54) METHOD AND APPARATUS FOR PROCESSING LIVE AUDIO AND VIDEO STREAM, AND DEVICE AND MEDIUM

(71) Applicant: Beijing Zitiao Network Technology Co., Ltd., Haidian District, Beijing (CN)

(72) Inventor: Nanshan LIAO, Beijing (CN)

(21) Appl. No.: 18/856,859

(22) PCT Filed: Apr. 3, 2023
(86) PCT No.: PCT/CN2023/085866

§ 371 Date: Oct. 14, 2024

(30) Foreign Application Priority Data
Apr. 14, 2022 (CN) 202210395011.9

(51) Int. Cl. H04N 21/2187; H04N 21/2368

(52) U.S. Cl. CPC H04N 21/2187; H04N 21/2368

(57) ABSTRACT

The embodiments of the present disclosure relate to a method and apparatus for processing a live audio and video stream, and a device and a medium. The method comprises: in response to a live connection operation with a second client, a first client sending a live connection request for the second client; receiving a second live audio and video stream corresponding to the second client; and in response to a received live connection permission message corresponding to the second client, playing a merged audio and video stream, wherein the merged audio and video stream is obtained by means of performing merging processing according to the second live audio and video stream and a first live audio and video stream, and the live connection permission message is a permission message for the live connection request.

### CROSS-REFERENCE TO RELATED APPLICATIONS

The present application is a National Stage Entry of International application No. PCT/CN2023/085866 filed on Apr. 3, 2023, which based on and claims the priority to the Chinese application No. 202210395011.9 filed on Apr. 14, 2022, and entitled “METHOD AND APPARATUS FOR PROCESSING LIVE AUDIO AND VIDEO STREAM, AND DEVICE AND MEDIUM”, the disclosure of which is incorporated by reference herein in its entirety.

### TECHNICAL FIELD

The present disclosure relates to the technical field of video processing, and in particular, to a method and apparatus for processing a live audio and video stream, a device and a medium.

### BACKGROUND

With the development of computer technology, a live has gradually risen, and in order to meet various live requirements of users, functions of the live have been increasingly diversified. For example, during a live, a client of the live can, as an inviter, invite another client of the live for live connection, and after the live connection is permitted by the other live client, an audio and video conversation between two live rooms can be achieved, thereby achieving an effect of live interaction.

### SUMMARY

The present disclosure provides a method and apparatus for processing a live stream, a device and a medium.

An embodiment of the present disclosure provides a method for processing a live stream, applied to a first client, comprising: in response to a live connection operation with a second client, sending a live connection request for the second client; receiving a second live stream corresponding to the second client; and in response to a received live connection permission message corresponding to the second client, playing a merged stream, wherein the merged stream is obtained by performing merging processing according to the second live stream corresponding to the second client and a first live stream corresponding to the first client, and the live connection permission message is a permission message for the live connection request.

An embodiment of the present disclosure provides a method for processing a live stream, applied to a second client, comprising: in response to a received live connection request of a first client, obtaining a first live stream corresponding to the first client; and in response to a live connection confirmation operation, feeding back a live connection permission message, and playing a merged stream, wherein the merged stream is obtained by performing merging processing according to the first live stream corresponding to the first client and a second live stream corresponding to the second client, the live connection confirmation operation is a confirmation connection operation for the live connection request, and the live connection permission message is a permission message for the live connection request.

An embodiment of the present disclosure further provides an apparatus for processing a live stream, applied to a first client, comprising: a sending module configured to, in response to a live connection operation with a second client, send a live connection request for the second client; a first receiving module configured to receive a second live stream corresponding to the second client; and a first merging playing module configured to, in response to a received live connection permission message corresponding to the second client, play a merged stream, wherein the merged stream is obtained by performing merging processing according to the second live stream corresponding to the second client and a first live stream corresponding to the first client, and the live connection permission message is a permission message for the live connection request.

An embodiment of the present disclosure further provides an apparatus for processing a live stream, applied to a second client, comprising: a second receiving module configured to, in response to a received live connection request of a first client, obtain a first live stream corresponding to the first client; a feedback module configured to, in response to a live connection confirmation operation, feed back a live connection permission message; and a second merging playing module configured to, in response to a live connection confirmation operation, play a merged stream, wherein the merged stream is obtained by performing merging processing according to the first live stream corresponding to the first client and a second live stream corresponding to the second client, the live connection confirmation operation is a confirmation connection operation for the live connection request, and the live connection permission message is a permission message for the live connection request.

An embodiment of the present disclosure further provides an electronic device, comprising: a processor; and a memory configured to store instructions executable by the processor, the processor being configured to read the executable instruction from the memory, and execute the instructions to implement the method for processing a live stream according to the embodiment of the present disclosure.

An embodiment of the present disclosure further provides a computer-readable storage medium having thereon stored a computer program, for performing the method for processing a live stream according to the embodiment of the present disclosure.

An embodiment of the present disclosure further provides a computer program, comprising: instructions which, when executed by a processor, cause the processor to perform the method for processing a live stream according to the embodiment of the present disclosure.

In embodiments of the present disclosure, the stream may comprise at least one of audio stream or video stream. For clarity, the following explanation will use audio and video stream as examples.

### BRIEF DESCRIPTION OF THE DRAWINGS

The above and other features, advantages, and aspects of embodiments of the present disclosure will become more apparent by combining the accompanying drawings and referring to the following specific implementations. Throughout the drawings, the same or similar reference numbers refer to the same or similar elements. It should be understood that the drawings are schematic and that components and elements are not necessarily drawn to scale.

FIG. 1 is a schematic diagram of a process of processing a live audio and video stream according to the related art;

FIG. 2 is a schematic diagram of a process of processing a live audio and video stream according to an embodiment of the present disclosure;

FIG. 3 is a schematic flow diagram of a method for processing a live audio and video stream according to an embodiment of the present disclosure;

FIG. 4 is a schematic flow diagram of another method for processing a live audio and video stream according to an embodiment of the present disclosure;

FIG. 5 is a schematic diagram of a scenario for processing a live audio and video stream according to an embodiment of the present disclosure;

FIG. 6 is a schematic diagram of a scenario for processing a live audio and video stream according to another embodiment of the present disclosure;

FIG. 7 is a schematic diagram of a scenario for processing a live audio and video stream according to another embodiment of the present disclosure;

FIG. 8 is a schematic flow diagram of another method for processing a live audio and video stream according to an embodiment of the present disclosure;

FIG. 9 is a schematic flow diagram of another method for processing a live audio and video stream according to an embodiment of the present disclosure;

FIG. 10 is a schematic diagram of a scenario for processing a live audio and video stream according to another embodiment of the present disclosure;

FIG. 11 is a schematic diagram of a process of processing a live audio and video stream according to another embodiment of the present disclosure;

FIG. 12 is a schematic structural diagram of an apparatus for processing a live audio and video stream according to an embodiment of the present disclosure;

FIG. 13 is a schematic structural diagram of another apparatus for processing a live audio and video stream according to an embodiment of the present disclosure;

FIG. 14 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure instead. It should be understood that the drawings and the embodiments of the present disclosure are for exemplary purposes only and are not intended to limit the scope of protection of the present disclosure.

It should be understood that various steps recited in method implementations of the present disclosure may be performed in a different order, and/or performed in parallel. Furthermore, the method implementations may include additional steps and/or omit performing the illustrated steps. The scope of the present disclosure is not limited in this respect.

The term “including” and variations thereof used herein are intended to be open-minded, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Definitions related to other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that modifications of “a” or “a plurality” mentioned in this disclosure are intended to be illustrative rather than restrictive, and that those skilled in the art should appreciate that they should be understood as “one or more” unless otherwise explicitly stated in the context.

Names of messages or information exchanged between a plurality of devices in the implementations of the present disclosure are for illustrative purposes only, and are not intended to limit the scope of the messages or information.

In the related art, a live connection request is sent by a client A on one side of a live to a client B on another side of the live, after receiving the request, the B sends a message permitting live connection to the A if a permission operation is performed, after the A receives the message permitting live connection, the A and B join a communication channel of the live, and based on the communication channel, the A and B both push their own audio and video streams to a remote terminal, so as to perform merging playing processing based on the audio and video stream.

In the above live connection operation, after performing the permission operation for the live connection, the invitee B still needs to go through a series of processes to see a screen of the inviter A and hear sound of the A, and similarly, the inviter A cannot see a screen of the B until having received the permission message for the live connection of the invitee B for a long time. Thus, this causes wait latency in the connection of the live.

In order to solve or at least partially solve the above technical problems, the present disclosure provides a method and apparatus for processing a live audio and video stream, and a device and a medium, so as to solve the problem of inefficient screen rendering during live connection in the related art.

Compared with the related art, the technical solution provided by the embodiment of the present disclosure has the following advantages.

According to the solution for processing a live audio and video stream provided in embodiments of the present disclosure, in response to a live connection operation with a second client, a first client sends a live connection request for the second client, and then receives a second live audio and video stream corresponding to the second client, i.e., starting to pre-pull the second live audio and video stream of the second client, and in response to a received live connection permission message corresponding to the second client, plays a merged audio and video stream, wherein the merged audio and video stream is generated by performing merging according to the second live audio and video stream corresponding to the second client and a first live audio and video stream corresponding to the first client, and the live connection permission message is a permission message for the live connection request. Therefore, the screen rendering efficiency during the live connection is improved, and the rendering waiting latency is avoided.

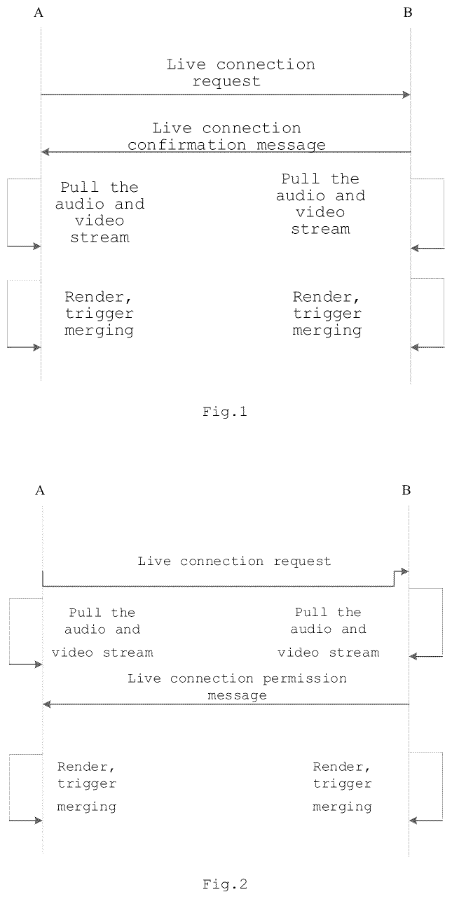

In order to solve the problem mentioned above, as shown in FIG. 1, when a inviter client A invites a client B to establish a live connection, only after a live connection permission message of the B is received, the A and B can pull live audio and video stream of the opposite side, render onto a screen, trigger merging, and the like. This means that the user need to wait for the completion of the series of operations to see the live audio and video stream of the opposite side, which will causes the problem such as wait latency of the live connection and affecting the live experience of the user.

In order to solve the problem mentioned above, an embodiment of the present disclosure provides a method for processing a live audio and video stream. In the method, as shown in FIG. 2, operations such as pulling a live audio and video stream of an opposite side and pushing a live audio and video stream of one's own are performed directly after A performs a live connection operation, and after a live connection permission message of B is received, only rendering onto a screen and triggering merging are to be performed, so that a time for which the user needs to wait is greatly shortened at once, and after a live connection confirmation operation is performed, only the rendering onto a screen and triggering merging playing processing are to be performed, so that a time for which the user needs to wait is greatly shortened at once.

In order to more fully describe the method for processing a live audio and video stream of the embodiment of the present disclosure, the descriptions focusing on a first client and a second client will be made below, respectively, wherein the first client may be understood as a client being an inviter of live connection, including but not limited to, a client device, server, etc. The second client may be understood as a client being an invitee of the live connection, including but not limited to a client device, server, etc.

The description focusing on the first client will be made first, which is specifically as follows:

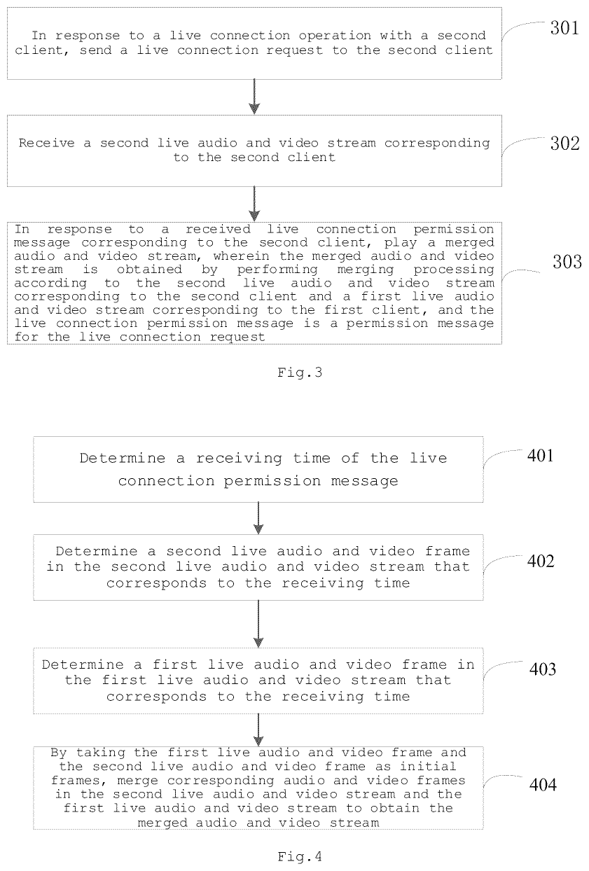

FIG. 3 is a schematic flow diagram of a method for processing a live audio and video stream according to an embodiment of the present disclosure, which may be executed by a first client provided with an apparatus for processing a live audio and video stream, wherein the apparatus may be implemented by software and/or hardware, and may generally be integrated in an electronic device where the first client is located. As shown in FIG. 3, the method comprises:
step 301, in response to a live connection operation with a second client, sending a live connection request to the second client.

The live connection operation is usually an audio sharing operation in a live scenario, that is, audio sharing between the first client and the second client during the live can be achieved through the live connection operation, wherein the first client can be an inviter, i.e., an anchor sending an audio sharing invitation, the second client can be an invitee, i.e., an anchor receiving the audio sharing invitation, the live connection operation with the second client is a live connection operation of the first client with the second client, which can be triggered by a live connection control on the first client, or by executing a voice operation, or by executing a gesture operation, and the like, which is not limited here.

In this embodiment, in response to a live connection operation with a second client, a live connection request is sent to the second client, wherein in some possible embodiments, a live connection request carrying a client identification of the second client may be sent to a business server of live connection, and the business server sends the live connection request to the second client.

Step 302, receiving a second live audio and video stream corresponding to the second client.

In this embodiment, in order to improve the screen rendering efficiency during the live connection, after the live connection request to the second client is sent, a real-time receiving operation on the second live audio and video stream of the second client is directly started.

Specifically, in some embodiments, in response to sending the live connection request to the second client, the second live audio and video stream corresponding to the second client is received.

In this embodiment, the first client subscribes to the second live audio and video stream of the second client, wherein if a first server is a real time communication (RTC) server, the second client may push the second live audio and video stream to the RTC server in real time, so that the first client may send an obtaining request of the second live audio and video stream to the preset RTC server, wherein the obtaining request includes the client identification of the second client, and then obtain the second live audio and video stream of the second client fed back by the RTC server, thereby ensuring that the second live audio and video stream can be pulled in time, and further improving the live connection efficiency.

It should be noted that, if the second live audio and video stream is obtained based on the RTC server, due to real-time transmission of the second live audio and video stream of the second client by the RTC, an obtaining granularity of the first client is to obtain second live audio and video frames of the second live audio and video stream frame by frame, and in order to reduce memory pressure of the first client, the first client only stores a currently obtained latest second live audio and video frame, so that when one second live audio and video frame is obtained, a second live audio and video frame obtained in a previous frame is cleared.

Certainly, in some possible embodiments, the number of audio and video frames to be saved may also be determined according to a remaining memory of the first client, for example, the remaining memory of the first client is obtained, and a storage number of audio and video frames corresponding to the remaining memory that is determined based on a preset correspondence is queried, so that after obtaining one second audio and video frame of the second client, the first client stores the corresponding second audio and video frame and performs counting processing, and when the counting result reaches a preset storage number of audio and video frames, it is considered that a maximum capacity of the remaining memory is reached, at this time, a historically obtained second video frame is deleted according to the currently obtained second video frame, which is specifically that in terms of a subsequently obtained second audio and video frame, when the first client obtains one new second audio and video frame, it deletes one earliest obtained second audio and video frame in the currently stored second audio and video frames, and saves the one new second audio and video frame obtained, so that the first client only saves the storage number of currently obtained latest second audio and video frames of second live audio and video frames, and when one second live audio and video frame is obtained, clears one earliest obtained second live audio and video frame. Therefore, by storing the plurality of second live audio and video frames of the second live audio and video stream, merging retry and the like can be performed when an error occurs in the merging processing.

Step 303, in response to a received live connection permission message corresponding to the second client, playing a merged audio and video stream, wherein the merged audio and video stream is obtained by performing merging processing according to the second live audio and video stream corresponding to the second client and a first live audio and video stream corresponding to the first client, and the live connection permission message is a permission message for the live connection request.

In this embodiment, if the live connection permission message of the second client fed back according to the live connection request is obtained, for example, the live connection permission message of the second client sent by the business server is obtained, the obtained second live audio and video frame corresponding to the second live audio and video stream is directly read, that is, there is no need to pull a second live audio and video stream corresponding to a real-time obtaining operation, but rather according to the pre-obtained second live audio and video frame in the second live audio and video stream, merging playing processing is performed according to the second live audio and video frame in the second live audio and video stream and a first live audio and video frame in the first live audio and video stream of the first client, that is, a merged audio and video stream corresponding to the second live audio and video frame in the second live audio and video stream and the first live audio and video frame in the first live audio and video stream of the first client is played, so that the screen rendering efficiency during the live connection is greatly improved.

In some possible embodiments, the merged audio and video stream may be fed back to the first client after merging processing by a preset second server.

In this embodiment, a merging processing request is sent to the preset second server, wherein the merging processing request has therein carried the second live audio and video stream corresponding to the second client and the first live audio and video stream corresponding to the first client, and the second server generates the merged audio and video stream and feeds it back to the first client for playing by the first client, thereby reducing a computing power requirement for the first client.

In other possible embodiments, the merged audio and video stream is generated locally at the first client, thereby avoiding communication with the second server to obtain the corresponding merged audio and video stream, and not affecting the obtaining of the merged audio and video stream even when the network speed is not good. In this embodiment, the first client performs merging processing according to the second live audio and video stream corresponding to the second client and the first live audio and video stream corresponding to the first client to obtain the merged audio and video stream.

In an embodiment of the present disclosure, if the second client performs a live connection cancellation operation, in response to a live connection cancellation message of the second client fed back according to the live connection request, for example, the business server stops, according to the live connection cancellation message of the second client that is fed back according to the live connection request, performing pushing of the first live audio and video stream of the first client to the preset RTC, so that a waste of network resources caused by continuous pushing of the first live audio and video stream to the first server by the first client is avoided, and in this embodiment, it is also possible to stop obtaining the second live audio and video stream of the second client and delete the already obtained second live audio and video stream of the second client to reduce the pressure on the memory of the first client.

In an embodiment of the present disclosure, in order to facilitate that the second client may pre-pull the first live audio and video stream of the first client, the first client starts to perform pushing of the first live audio and video stream of the first client to the preset RTC in response to the live connection operation.

In summary, according to the method for processing a live audio and video stream of the embodiment of the present disclosure, a first client sends, in response to a live connection operation with a second client, a live connection request for the second client, and then receives a second live audio and video stream corresponding to the second client, that is, pre-pulls the second live audio and video stream of the second client, and in response to a received live connection permission message corresponding to the second client, plays a merged audio and video stream, wherein the merged audio and video stream is generated by performing merging according to the second live audio and video stream corresponding to the second client and a first live audio and video stream corresponding to the first client, and the live connection permission message is a permission message for the live connection request. Therefore, after the live connection permission message of the opposite terminal is received, merging playing processing can be directly performed according to the pre-pulled live audio and video stream, so that a duration for pulling the stream after the live connection permission message is received is saved, the screen rendering efficiency during the live connection is improved, and the rendering waiting latency is avoided.

In an actual execution process, if the merged audio and video stream is generated locally at the first client, in different application scenarios, there are different ways in which the first client performs merging processing on the second live audio and video stream corresponding to the second client and the first live audio and video stream corresponding to the first client to obtain the merged audio and video stream, which are exemplified as follows:

In an embodiment of the present disclosure, as shown in FIG. 4, performing merging processing on the second live audio and video stream of the second client and the first live audio and video stream of the first client comprises:
step 401, determining a receiving time of the live connection permission message.

In this embodiment, a system time when the live connection permission message is received is determined, and the system time is determined as the receiving time.

Step 402, determining a second live audio and video frame in the second live audio and video stream that corresponds to the receiving time.

Step 403, determining a first live audio and video frame in the first live audio and video stream that corresponds to the receiving time.

The execution order of the steps 402 and 403 is not limited, and they may be executed simultaneously.

In this embodiment, in order to achieve the real-time merging effect, a second live audio and video frame in the second live audio and video stream that is latest pulled at the current receiving time may be obtained as the second live audio and video frame corresponding to the receiving time, or a stream pushing time of each audio and video frame in the second live audio and video stream may be identified, the stream pushing time is matched with the receiving time, and a successfully matched audio and video frame is determined as the second live audio and video frame.

Similarly, in this embodiment, a latest first live audio and video frame in the first live audio and video stream at the current receiving time may be obtained as the first live audio and video frame corresponding to the receiving time, or a stream pushing time of each first live audio and video frame in the first live audio and video stream may be identified, the stream pushing time is matched with the receiving time, and a successfully matched audio and video frame is determined as the first live audio and video frame.

Step 404, by taking the first live audio and video frame and the second live audio and video frame as initial frames, performing merging processing on corresponding audio and video frames in the second live audio and video stream and the first live audio and video stream to obtain the merged audio and video stream.

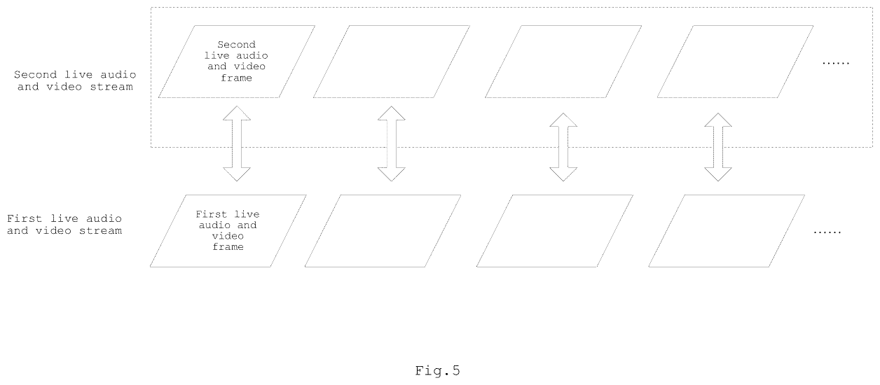

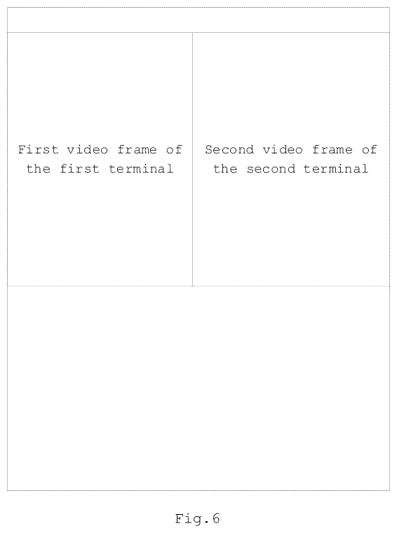

In this embodiment, as shown in FIG. 5, by taking the first live audio and video frame and the second live audio and video frame as initial frames, according to UI structure information of the first client and the like, a first video frame in the first live audio and video frame and a second video frame in the second live audio frame are combined and a combined video frame is obtained by rendering, wherein the combined video frame may be as shown in FIG. 6, with the first video frame of the first client displayed on a left side and the second video frame of the second client displayed on a right side. At the same time, merging playing is performed on a first audio frame in the first live audio and video frame and a second audio frame in the second live audio and video frame.

Then, a next second live audio and video frame of the second live audio and video stream that is obtained in real time and a next first live audio and video frame of the first live audio and video stream are read to perform merging processing for a merged video stream formed by merged video frames.

During the merging processing, another index connection display element in the live connection scenario may also be superimposed, for example, when the merging processing is performed, a first current audio and video frame in the first live audio and video stream and a second current audio and video frame in the second live audio and video stream are determined, the first current audio and video frame and the second current audio and video frame are combined to obtain a candidate combined audio and video frame, a preset rendering parameter is obtained, a corresponding live connection display element is rendered according to the rendering parameter, wherein the live connection display element may be “PK progress bar” as shown in FIG. 7, and the like, and the rendering parameter includes a display content, display mode, display position, display color, and the like of the corresponding display element, then the live connection display element is rendered in the candidate combined audio and video frame according to the rendering parameter to obtain a target combined audio and video frame, and a merged audio and video stream formed by the continuous target combined audio and video frames is displayed, thereby ensuring the display effect of the merging.

In another embodiment of the present disclosure, when merging processing is performed on the second live audio and video stream corresponding to the real-time obtaining operation and the first live audio and video stream of the first client, in order to further improve the screen display efficiency during the live, when the live connection permission message is obtained, a recently obtained second audio and video frame may also be read, and the current second audio and video frame latest obtained and the first audio and video frame in the first live audio and video stream are continually combined.

When the video frames are combined, fixed elements in the first live audio and video frame and the second live audio and video frame may be further determined, for example, an element type of each image element in the first live audio and video frame and the second live audio and video frame is determined, and a fixed element is determined according to the element type, for example, anchor's avatar information, and live background information, and therefore, when the first live audio and video frame and the second live audio and video frame are combined, combined image areas of fixed elements in one previous first live audio and video frame and one previous second live audio and video frame are reused, only for image areas corresponding to non-fixed elements, greatly improving the combination efficiency.

In summary, according to the method for processing a live audio and video stream of the embodiment of the present disclosure, after the live connection permission message is obtained, merging display processing is directly performed, so that the screen rendering efficiency during the live connection is improved.

Next, the description of the method for processing a live audio and video stream according to the embodiment of the present disclosure that focuses on the second client will be made.

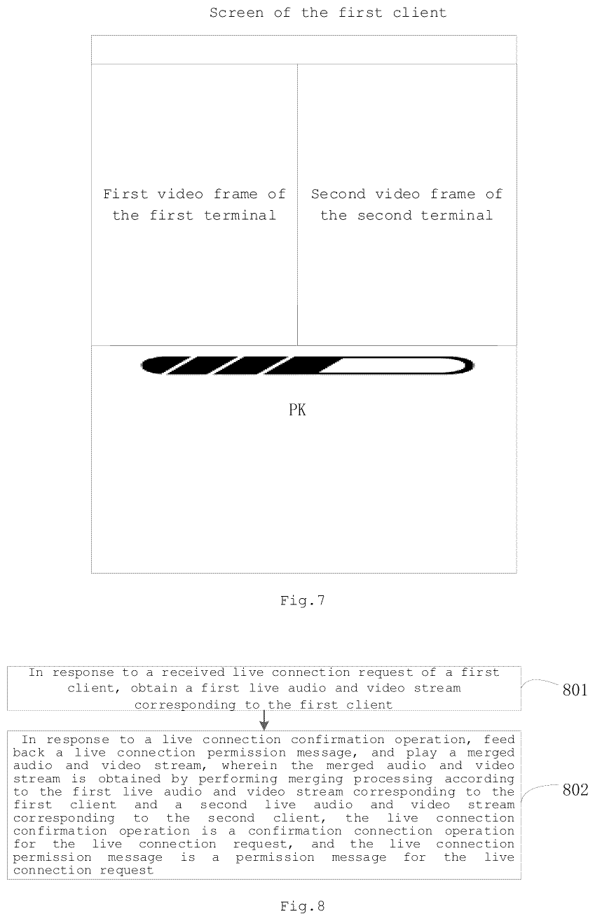

FIG. 8 is a flow diagram of a method for processing a live audio and video stream according to an embodiment of the present disclosure, as shown in FIG. 8, the method comprising:
step 801, in response to a received live connection request of a first client, obtaining a first live audio and video stream corresponding to the first client.

The live connection request sent by the first client may be forwarded by a business server and in this embodiment, immediately after the live connection request is obtained, the first live audio and video stream of the first client is pulled, and since the first client has pre-pushed the first live audio and video stream to a preset RTC server, in an embodiment of the present disclosure, it is possible to subscribe to the first live audio and video stream of the first client by a preset first server, such as the RTC server.

It should be noted that, due to real-time transmission of the first live audio and video stream of the first client, an obtaining granularity of the second client is to obtain first live audio and video frames in the first live audio and video stream frame by frame, and in order to reduce memory pressure of the second client, the second client only stores a currently obtained latest first live audio and video frame, and when one first live audio and video frame is obtained, one previous first live audio and video frame is cleared.

Certainly, the number of audio and video frames to be saved may be determined according to a remaining memory of the second client, for example, the remaining memory of the second client is obtained, and a storage number of audio and video frames corresponding to the remaining memory that is determined based on a preset correspondence is queried, so that the second client only saves the storage number of currently obtained latest first live audio and video frames of the first live audio and video frames, and when one first live audio and video frame is obtained, one earliest obtained first live audio and video frame is cleared. Therefore, by storing a plurality of first live audio and video frames, when an error occurs in the merging processing, merging retry or the like can be performed.

In this embodiment, similarly, the second client also starts to perform, in response to the live connection request, pushing of the second live audio and video stream of the second client to the preset RTC, to facilitate that the first client can pre-pull the second live audio and video stream of the second client.

Step 802, in response to a live connection confirmation operation, feeding back a live connection permission message, and playing a merged audio and video stream, wherein the merged audio and video stream is obtained by performing merging processing according to the first live audio and video stream corresponding to the first client and a second live audio and video stream corresponding to the second client, the live connection confirmation operation is a confirmation connection operation for the live connection request, and the live connection permission message is a permission message for the live connection request.

In an embodiment of the present disclosure, a live connection confirmation operation for the live connection request is responded, which may be triggered by a user voice of the second client, or by a gesture trajectory, or by triggering a corresponding connection control, or the like.

In response to the live connection confirmation operation for the live connection request, the live connection permission message of the first client may be fed back to the business server, and then the merged audio and video stream is played, thereby improving the efficiency of the merging playing.

The merged audio and video stream is obtained by performing merging processing according to the first live audio and video stream corresponding to the first client and the second live audio and video stream corresponding to the second client.

In some possible embodiments, the merged audio and video stream may be fed back to the second client after merging processing of a preset second server.

In this embodiment, in order to reduce the computing power consumption of the second client, a merging processing request is sent to the preset second server, wherein the merging processing request has therein carried the second live audio and video stream corresponding to the second client and the first live audio and video stream corresponding to the first client, and the preset second server generates the merged audio and video stream and feeds it back to the second client for playing by the second client.

In other possible embodiments, the merged audio and video stream is generated locally at the second client, so that the merged audio and video stream can be obtained even when the network of the second client is not good. In this embodiment, the second client performs merging processing on the second live audio and video stream corresponding to the second client and the first live audio and video stream corresponding to the first client to obtain the merged audio and video stream. In an embodiment of the present disclosure, if the second client performs a live connection cancellation operation, that is, the second client performs a cancellation operation on the live connection request, for example, triggers a “Cancel” control, a live connection cancellation message is fed back to the business server, so that the first client may obtain the live connection cancellation message to stop performing pushing of the first live audio and video stream of the first client to the first server, so as to avoid a waste of network resources due to continuous pushing. In this embodiment, it is also possible to stop obtaining the first live audio and video stream of the first client, and delete the already obtained first live audio and video stream of the first client.

In summary, according to the method for processing a live audio and video stream of the embodiment of the present disclosure, a second client obtains, in response to a received live connection request of a first client, a first live audio and video stream corresponding to the first client, and then, in response to a live connection confirmation operation, feeds back a live connection permission message, and plays a merged audio and video stream, wherein the merged audio and video stream is obtained by performing merging processing according to the first live audio and video stream corresponding to the first client and a second live audio and video stream corresponding to the second client, the live connection confirmation operation is a confirmation connection operation for the live connection request, and the live connection permission message is a permission message for the live connection request. Therefore, the live audio and video stream of the opposite client are pre-obtained, and after the live connection permission operation is obtained, the merged audio and video stream obtained by performing merging processing according to the first live audio and video stream corresponding to the first client and the second live audio and video stream corresponding to the second client is directly played, so that the screen rendering efficiency during live connection is improved, and waiting latency is avoided.

In an actual execution process, merging processing is performed locally at the second client according to the first live audio and video stream corresponding to the first client and the second live audio and video stream corresponding to the second client, and in different application scenarios, there are different ways of performing merging processing on a corresponding first live audio and video stream and second client's second live audio and video stream, which are exemplified as follows:

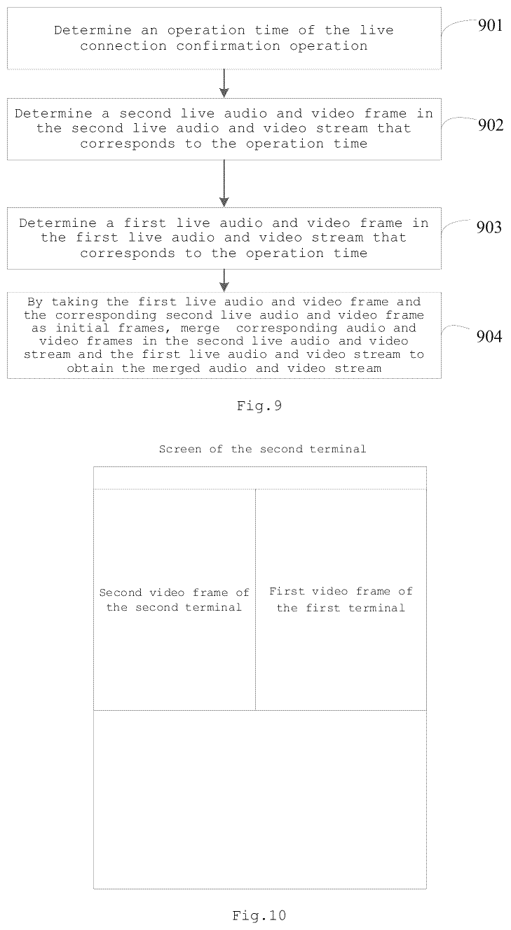

In an embodiment of the present disclosure, as shown in FIG. 9, performing merging processing on a corresponding first live audio and video stream and second client's second live audio and video stream comprises:
step 901, determining an operation time of the live connection confirmation operation.

In this embodiment, a system time when the live connection confirmation operation is performed is determined, and the system time is determined as the operation time.

Step 902, determining a second live audio and video frame in the second live audio and video stream that corresponds to the operation time.

Step 903, determining a first live audio and video frame in the first live audio and video stream that corresponds to the operation time.

The execution order of the steps 902 and 903 is not limited, and they may also be executed simultaneously.

In this embodiment, in order to implement a real-time merging effect, a first live audio and video frame in the first live audio and video stream that is latest pulled at a current operation time may be obtained as the first live audio and video frame corresponding to the operation time, or a stream pushing time of each audio and video frame in the first live audio and video stream may be identified, the stream pushing time is matched with the operation time, and a successfully matched audio and video frame is determined as the first live audio and video frame.

Similarly, in this embodiment, a latest second live audio and video frame in the second live audio and video stream at the current operation time may be obtained as a second live audio and video frame corresponding to the operation time, or a stream pushing time of each second live audio and video frame in the second live audio and video stream may also be identified, the stream pushing time is matched with the operation time, and a successfully matched audio and video frame is determined as the second live audio and video frame.

Step 904, by taking the first live audio and video frame and the corresponding second live audio and video frame as initial frames, merging corresponding audio and video frames in the second live audio and video stream and the first live audio and video stream to obtain the merged audio and video stream.

In this embodiment, by taking the first live audio and video frame and the second audio and video frame as initial frames, according to UI structure information of the first client and the like, a video frame in the first live audio and video frame and a video frame in the second live audio frame are combined to obtain a combined video frame, wherein the combined video frame may be as shown in FIG. 10, with the second live video frame of the second client displayed on a left side and the first live video frame of the first client displayed on a right side. At the same time, a first audio frame in the first live audio and video frame and a second audio frame in the second live audio frame are merged.

Then, a next first live audio and video frame of the first live audio and video stream that is obtained in real time and a next second live audio and video frame of the second live audio and video stream are read to perform the above merging operation.

During the merging processing, another display element in the live connection scenario may also be superimposed, for example, when the merging processing is performed, a first current audio and video frame in a first live audio and video stream and a second current audio and video frame in the second live audio and video stream are determined, the first current audio and video frame and the second current audio and video frame are combined to obtain a candidate combined audio and video frame, a preset rendering parameter is obtained to perform rendering display on a live connection display element according to the rendering parameter, wherein the live connection display element is an interface element displayed by the first client and the second client in the live connection (such as audio sharing and connection) scenario, which may be, for example, “PK progress bar” and the like, and the rendering parameter includes a display content, display mode, display position, display color and the like of the corresponding live connection display element, then the live connection display element is rendered in the candidate combined audio and video frame according to the rendering parameter to obtain a target combined audio and video frame, and the merged audio and video stream is obtained according to the target combined audio and video frame.

In another embodiment of the present disclosure, when merging processing is performed on the first live audio and video stream corresponding to the real-time obtaining operation and the second live audio and video stream of the second client, in order to further improve the screen display efficiency during the live, when a live connection confirmation operation is obtained, the last obtained first live audio and video frame may be read, to continuously combine the current first live audio and video frame latest obtained and the second live audio and video frame in the second live audio and video stream.

When the first live audio and video frame and the second live audio and video frame are combined, fixed elements in the first live audio and video frame and the second live audio and video frame may also be determined, for example, an element type of each image element in the first live audio and video frame and the second live audio and video frame is determined, and a fixed element is determined according to the element type, for example, live background information, and therefore, when the first live video frame and the second live audio and video frame are combined, combined image areas of fixed elements of one previous first live video frame and one previous second live audio and video frame are reused, and only image areas corresponding to non-fixed elements are subjected to combination processing, greatly improving the combination efficiency.

In order to provide a more comprehensive description of the method for processing a live audio and video stream according to the embodiment of the present disclosure, an example will be taken below in conjunction with a specific application scenario, wherein in the scenario, a first client is A, a second client is B, related messages of the A and B are interacted through a business server, and a live connection between the A and B is transmitted in real time through RTC, which is exemplified as follows:

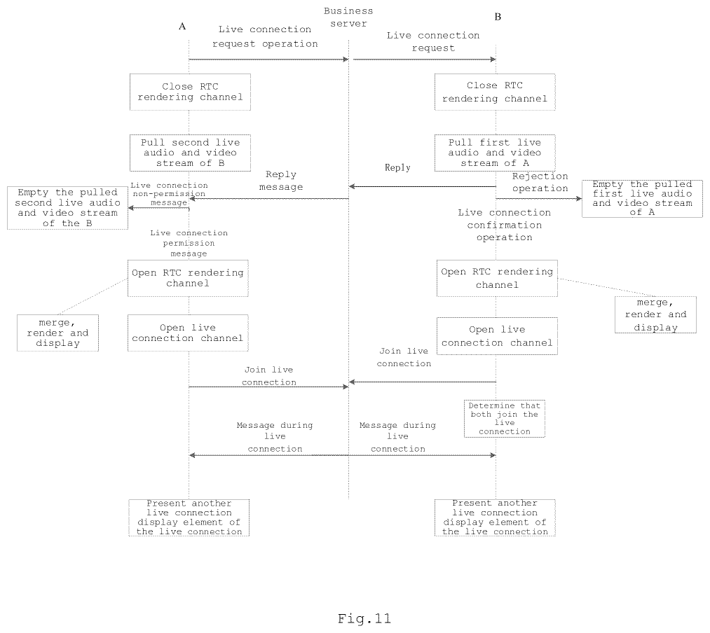

As shown in FIG. 11, after the A sends a live connection request to the business server, an RTC rendering channel for the live is closed, but A starts to push a first live audio and video frame of the A to the RTC and pull a second live audio and video stream of the B.

After the B obtains the live connection request of the A, an RTC rendering channel for the live is closed, but B starts to push the second live audio and video frame of the B to the RTC and pull the first live audio and video stream of the A.

If the B executes a live connection confirmation operation, a live connection permission message can be sent to the A through the business server and the like, after the A receives the live connection permission message, the RTC rendering channel for the live is opened, and a live connection channel is opened, on the A side, a video of the opposite side is immediately rendered (including UI adjustment, adding surfaceview of the opposite side, etc.), an audio of the opposite side is played, and a merging operation is triggered.

After the B executes the live connection confirmation operation, the RTC rendering channel of the B is opened, a live connection channel is opened, on the B side, a video of the opposite side is immediately rendered (including UI adjustment, adding surfaceview of the opposite side, etc.), an audio of the opposite side is played, and a merging operation is triggered.

If the B executes a live connection cancellation operation, a live connection cancellation message can be sent to the A through the business server and the like, and after the A receives the live connection cancellation message, the A empties the obtained second live audio and video stream of the B, and stops obtaining the second live audio and video stream of the B. Similarly, the B empties the obtained first live audio and video stream of the A and stops obtaining the first live audio and video stream of the A.

The live connection channel is opened, and the B can determine whether the live connection is currently in progress according to the number of users in an information list, for example, if the number of the users in “list message” is 2, it is indicated that the live connection channel between the A and the B has been established. During the merging displaying, another live connection display element (for example, a live progress bar, etc.) can be displayed on the merged video frame to increase the live interest.

In summary, according to the method for processing a live audio and video stream of the embodiment of the present disclosure, after a live connection confirmation operation is obtained, a merged audio and video stream obtained by performing combination processing according to the first live audio and video stream corresponding to the first client and the second live audio and video stream corresponding to the second client is directly played, so that the screen rendering efficiency during the live connection is improved.

In order to implement the above embodiments, the present disclosure further provides an apparatus for processing a live audio and video stream.

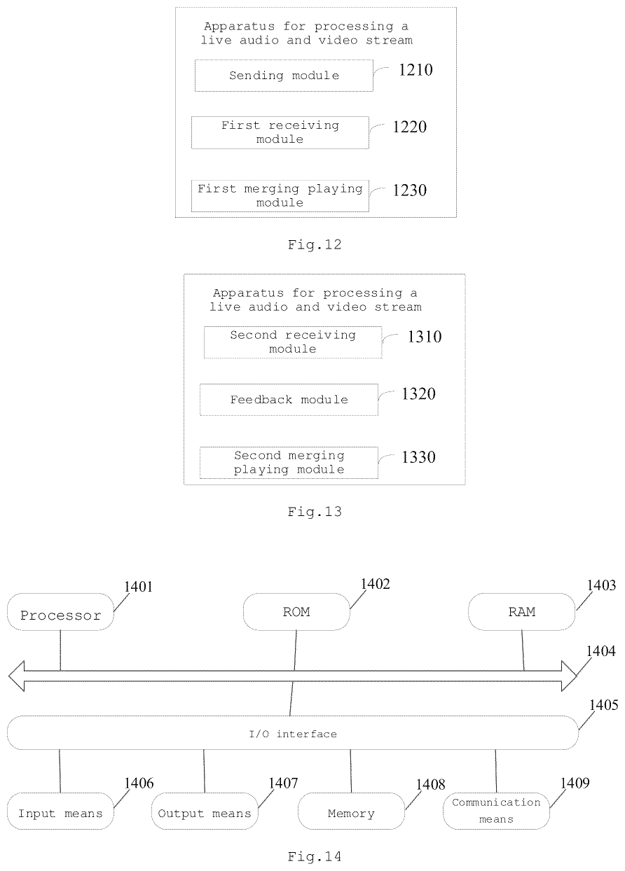

FIG. 12 is a schematic structural diagram of an apparatus for processing a live audio and video stream provided by an embodiment of the present disclosure, which may be implemented by software and/or hardware, and may be generally integrated on an electronic device side where a first client is located. As shown in FIG. 12, the apparatus comprises:
a sending module 1210 configured to, in response to a live connection operation with a second client, send a live connection request to the second client;
a first receiving module 1220 configured to receive a second live audio and video stream corresponding to the second client; and
a first merging playing module 1230 configured to, in response to a received live connection permission message corresponding to the second client, play a merged audio and video stream, wherein the merged audio and video stream is obtained by performing merging processing according to the second live audio and video stream corresponding to the second client and a first live audio and video stream corresponding to the first client, and the live connection permission message is a permission message for the live connection request.

The apparatus for processing a live audio and video stream provided by the embodiment of the present disclosure can perform the method for processing a live audio and video stream provided by any embodiment of the present disclosure, has corresponding functional modules and beneficial effects of executing the method, and has similar implementation principles, which are not repeated here.

FIG. 13 is a schematic structural diagram of an apparatus for processing a live audio and video stream provided by an embodiment of the present disclosure, which may be implemented by software and/or hardware, and may be generally integrated in an electronic device side where a second client is located. As shown in FIG. 13, the apparatus comprises:
a second receiving module 1310 configured to, in response to a received live connection request of a first client, obtain a first live audio and video stream corresponding to the first client;
a feedback module 1320 configured to, in response to a live connection confirmation operation, feed back a live connection permission message; and
a second merging playing module 1330 configured to, in response to the live connection confirmation operation, play a merged audio and video stream, wherein the merged audio and video stream is obtained by performing merging processing according to the first live audio and video stream corresponding to the first client and a second live audio and video stream corresponding to the second client, the live connection confirmation operation is a confirmation connection operation for the live connection request, and the live connection permission message is a permission message for the live connection request.

The apparatus for processing a live audio and video stream provided by the embodiment of the present disclosure can perform the method for processing a live audio and video stream provided by any embodiment of the present disclosure, has corresponding functional modules and beneficial effects of executing the method, and has similar implementation principles, which are not repeated here.

The above modules may be implemented as software components executed on one or more general-purpose processors, or implemented as hardware for performing certain functions, such as a programmable logic device and/or application specific integrated circuit. In some embodiments, these modules may be embodied in a form of a software product, which may be stored in a non-volatile storage media. These non-volatile storage media include instructions that cause a computer device (e.g., a personal computer, server, network device, mobile terminal, etc.) to perform the method described in the embodiment of the present disclosure. In some embodiments, the above modules may also be implemented on a single device or may be distributed on a plurality of devices. Functions of these modules may be combined with each other, or further divided into a plurality of sub-modules.

In order to implement the above embodiments, the present disclosure further provides a computer program product, comprising a computer program/instructions which, when executed by a processor, implement the method for processing a live audio and video stream in the above embodiments.

In some embodiments of the present application, there is further provided a computer program, comprising instructions which, when executed by a processor, cause the processor to implement the method for processing a live audio and video stream in the above embodiments.

FIG. 14 is a schematic structural diagram of an electronic device according to an embodiment of the present disclosure.

Referring to FIG. 14 specifically hereinafter, a schematic structural diagram of an electronic device 1400 suitable for implementing an embodiment of the present disclosure is shown. The electronic device 1400 in the embodiment of the present disclosure may include, but is not limited to, a mobile terminal such as a mobile phone, a laptop, a digital broadcast receiver, a PDA (Personal Digital Assistant), a PAD (Portable Android Device), a PMP (Portable Multimedia Player), a vehicle-mounted terminal (e.g., a vehicle-mounted navigation terminal), and the like, and a fixed terminal such as a digital TV and desktop. The electronic device shown in FIG. 14 is only an example, and should not bring any limitation to the functions and the scope of use of the embodiments of the present disclosure.

As shown in FIG. 14, the electronic device 1400 may include a processor (e.g., a central processing unit, graphics processing unit, etc.) 1401 that may perform various suitable actions and processes according to a program stored in a read-only memory (ROM) 1402 or a program loaded from a memory 1408 into a random access memory (RAM) 1403. In the RAM 1403, various programs and data required for the operation of the electronic device 1400 are also stored. The processor 1401, ROM 1402, and RAM 1403 are connected to each other by a bus 1404. An input/output (I/O) interface 1405 is also connected to the bus 1404.

Generally, the following means may be connected to the I/O interface 1405: an input means 1406 including, for example, a touch screen, touch pad, keyboard, mouse, camera, microphone, accelerometer, gyroscope, etc.; an output means 1407 including, for example, a liquid crystal display (LCD), speaker, vibrator, etc.; the memory 1408 including, for example, a magnetic tape, hard disk, etc.; and a communication means 1409. The communication means 1409 may allow the electronic device 1400 to communicate wirelessly or by wire with other devices to exchange data. While FIG. 14 illustrates the electronic device 1400 having various means, it should be understood that not all illustrated means are required to be implemented or provided. More or fewer means may be alternatively implemented or provided.

In particular, according to embodiments of the present disclosure, the processes described above with reference to the flow diagrams may be implemented as a computer software program. For example, embodiments of the present disclosure include a computer program product comprising a computer program carried on a non-transitory computer-readable medium, the computer program containing program code for performing the method illustrated by the flow diagram. In such an embodiment, the computer program may be downloaded and installed from a network via the communication means 1409, or installed from the memory 1408, or installed from the ROM 1402. The computer program, when executed by the processor 1401, performs the above functions defined in the method for processing a live audio and video stream of the embodiment of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. And, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some implementations, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has one or more programs carried thereon, wherein the above one or more programs, when executed by the electronic device, cause: a first client, in response to a live connection operation with a second client, sending a live connection request for the second client, then receiving a second live audio and video stream corresponding to the second client, i.e., starting to pre-pull the second live audio and video stream of the second client, and in response to a received live connection permission message corresponding to the second client, playing a merged audio and video stream, wherein the merged audio and video stream is generated by performing merging according to the second live audio and video stream corresponding to the second client and a first live audio and video stream corresponding to the first client, and the live connection permission message is a permission message for the live connection request. Therefore, the live audio and video stream of the opposite terminal can be pre-obtained by fully using a time from sending the live connection request to receiving the live connection permission message, and therefore, after the live connection permission message of the opposite terminal is obtained, merging display processing is directly performed, so that the screen rendering efficiency during the live connection is improved, and the rendering waiting latency is avoided.

The electronic device may write computer program code for performing the operations of the present disclosure in one or more programming languages, wherein the above programming language includes but is not limited to an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), an application specific integrated circuit (ASIC), an application specific standard parts (ASSP), a system on chip (SOC), a complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1-18. (canceled)

19. A method for processing a live stream, applied to a first client, comprising:
in response to a live connection operation with a second client, sending a live connection request for the second client;
receiving a second live stream corresponding to the second client; and
in response to receiving a live connection permission message corresponding to the second client, playing a merged stream, wherein the merged stream is obtained according to the second live stream corresponding to the second client and a first live stream corresponding to the first client, and the live connection permission message is a permission message for the live connection request.

20. The method of claim 19, wherein the method further comprises: sending an stream obtaining request to a first server, the stream obtaining request comprising a client identification of the second client; and
the receiving the second live stream corresponding to the second client comprises: receiving the second live stream of the second client transmitted by the first server.

21. The method of claim 19, wherein before the playing the merged stream, the method comprises:
performing merging processing on the second live stream corresponding to the second client and the first live stream corresponding to the first client to obtain the merged stream; or
sending a merging processing request to a second server, the merging processing request having therein carried the second live stream corresponding to the second client and the first live stream corresponding to the first client, and receiving the merged stream transmitted by the second server.

22. The method of claim 21, wherein the performing merging processing on the second live stream corresponding to the second client and the first live stream corresponding to the first client to obtain the merged stream, comprises:
determining a receiving time of the live connection permission message;
determining a first live audio and video frame in the first live stream that corresponds to the receiving time and a second live audio and video frame in the second live stream that corresponds to the receiving time; and
by taking the first live audio and video frame and the second live audio and video frame as initial frames, merging corresponding audio and video frames in the second live stream and the first live stream to obtain the merged stream.

23. The method of claim 22, wherein the merging the corresponding audio and video frames in the second live stream and the first live stream to obtain the merged stream, comprises:
during the merging, determining a first current audio and video frame in the first live stream and a second current audio and video frame in the second live stream;
combining the first current audio and video frame and the second current audio and video frame to obtain a candidate combined audio and video frame;
obtaining a preset rendering parameter;
rendering a live connection display element in the candidate combined audio and video frame according to the rendering parameter to obtain a target combined audio and video frame; and
obtaining the merged stream according to the target combined audio and video frame.

24. The method of claim 19, further comprising:
in response to that the live connection permission message is not received, deleting the received second live stream of the second client.

25. The method of claim 20, further comprising: in response to receiving a connection cancellation message corresponding to the second client, stopping performing pushing of the first live stream of the first client to the first server.

26. A method for processing a live stream, applied to a second client, comprising:
in response to a live connection request of a first client, receiving a first live stream corresponding to the first client; and
in response to a live connection confirmation operation, feeding back a live connection permission message, and playing a merged stream, wherein the merged stream is obtained by performing merging processing according to the first live stream corresponding to the first client and a second live stream corresponding to the second client, the live connection confirmation operation is a confirmation operation for the live connection request, and the live connection permission message is a permission message for the live connection request.

27. The method of claim 26, further comprising:
in response to the live connection request, pushing the second live stream of the second client to a first server.

28. The method of claim 26, wherein before the playing the merged stream, the method comprises:
performing merging processing on the first live stream corresponding to the first client and the second live stream corresponding to the second client to obtain the merged stream; or
sending a merging processing request to a second server, the merging processing request having therein carried the second live stream corresponding to the second client and the first live stream corresponding to the first client; and receiving the merged stream transmitted by the second server.

29. The method of claim 28, wherein the performing merging processing on the first live stream corresponding to the first client and the second live stream corresponding to the second client to obtain the merged stream, comprises:
determining an operation time of the live connection confirmation operation;
determining a first live audio and video frame in the first live stream that corresponds to the operation time and a second live audio and video frame in the second live stream that corresponds to the operation time; and
by taking the first live audio and video frame and the corresponding second live audio and video frame as initial frames, merging corresponding audio and video frames in the second live stream and the first live stream to obtain the merged stream.

30. The method of claim 27, further comprising:
in response to a live connection cancellation operation for the live connection request, stopping performing pushing of the second live stream of the second client to the first server.

31. An electronic device, comprising:
a processor; and
a memory configured to store instructions executable by the processor, the processor being configured to read the executable instructions from the memory, and execute the executable instructions to implement a method for processing a live stream, applied to a first client, comprising:
in response to a live connection operation with a second client, sending a live connection request for the second client;
receiving a second live stream corresponding to the second client; and
in response to receiving a live connection permission message corresponding to the second client, playing a merged stream, wherein the merged stream is obtained according to the second live stream corresponding to the second client and a first live stream corresponding to the first client, and the live connection permission message is a permission message for the live connection request.

32. A non-transitory computer-readable storage medium having therein stored a computer program, which, when executed by a processor, implement the method for processing a live stream according to claim 19.

33. An electronic device, comprising:
a processor; and
a memory configured to store instructions executable by the processor,
the processor being configured to read the executable instructions from the memory, and execute the executable instructions to implement the method for processing a live stream according to claim 26.

34. A non-transitory computer-readable storage medium having therein stored a computer program, which, when executed by a processor, implement the method for processing a live stream according to claim 26.

35. The electronic device of claim 31, wherein the method further comprises: sending a stream obtaining request to a first server, the stream obtaining request comprising a client identification of the second client; and
the receiving the second live stream corresponding to the second client comprises: receiving the second live stream of the second client transmitted by the first server.

36. The electronic device of claim 31, wherein before the playing the merged stream, the method comprises:
performing merging processing on the second live stream corresponding to the second client and the first live stream corresponding to the first client to obtain the merged stream; or
sending a merging processing request to a second server, the merging processing request having therein carried the second live stream corresponding to the second client and the first live stream corresponding to the first client, and receiving the merged stream transmitted by the second server.

37. The electronic device of claim 36, wherein the performing merging processing on the second live stream corresponding to the second client and the first live stream corresponding to the first client to obtain the merged stream, comprises:
determining a receiving time of the live connection permission message;
determining a first live audio and video frame in the first live stream that corresponds to the receiving time and a second live audio and video frame in the second live stream that corresponds to the receiving time; and
by taking the first live audio and video frame and the second live audio and video frame as initial frames, merging corresponding audio and video frames in the second live stream and the first live stream to obtain the merged stream.

38. The electronic device of claim 37, wherein the merging the corresponding audio and video frames in the second live stream and the first live stream to obtain the merged stream, comprises:
during the merging, determining a first current audio and video frame in the first live stream and a second current audio and video frame in the second live stream;
combining the first current audio and video frame and the second current audio and video frame to obtain a candidate combined audio and video frame;
obtaining a preset rendering parameter;
rendering a live connection display element in the candidate combined audio and video frame according to the rendering parameter to obtain a target combined audio and video frame; and
obtaining the merged stream according to the target combined audio and video frame.
